(19) United States
(12) Patent Application Publication
(10) Pub. No.: US 2021/0062546 A1
(43) Pub. Date: Mar. 4, 2021

(54) WIRELESSLY POWERED, ELECTRONIC DOOR LOCKING SYSTEM

(71) Applicant: Glen A. Robertson, Madison, AL (US)

(72) Inventor: Glen A. Robertson, Madison, AL (US)

(21) Appl. No.: 16/559,893

(22) Filed: Sep. 4, 2019

(51) Int. Cl. E05B 47/00; E05B 63/00; G07C 9/00; H02J 50/10

(52) U.S. Cl. CPC E05B 47/0004; H02J 50/10; G07C 9/0073; E05B 63/0017

(57) ABSTRACT

A wirelessly powered, electronic door locking system is provided comprising an electronic door lock, a door locking mechanism, dead bolt and door opening mechanism, and a wireless charging station between the door frame and the door to maintain a charge on a battery or capacitor that stores the energy needed to power the electronic door lock and operate a standard solenoid to place the door locking mechanism in a locked or unlocked state; in another embodiment the electronic door lock contains a Bi-Stable Permanent Magnet Activation System (BSPMAS) to operate a Dual Position Latching Solenoid (DPLS) and place the door locking mechanism in a locked or unlocked state in an energy efficient manner.

### FIELD OF TECHNOLOGY

This invention relates to a wirelessly powered, electronic door locking system, comprising an electronic door lock, a door locking mechanism, dead bolt and door opening mechanism, and a wireless charging station between the door frame and the door to maintain a charge on a battery or capacitor that stores the energy needed to power the electronic door lock and operate a standard solenoid to place the door locking mechanism in a locked or unlocked state; in another embodiment the wirelessly powered, electronic door lock contains a Bi-Stable Permanent Magnet Activation System (BSPMAS) to operate a Dual Position Latching Solenoid (DPLS) and place the door locking mechanism in a locked or unlocked state in an energy efficient manner.

### BACKGROUND ART

An electronic door lock often uses a solenoid to place a door locking mechanism in a locked or unlocked state. In the door locking mechanism's locked state, the solenoid's armature prevents the door locking mechanism from moving whereby, a dead bolt cannot be moved out of the door frame or the door handle cannot function to open the door. In the door locking mechanism's unlocked state, the solenoid is under electrical power to move and hold the solenoid's armature, whereby the door locking mechanism can freely operate allowing the dead bolt to be moved in and out of the door frame or the door handle to function to open the door.

Various examples of electronic door locks (as well as electronic door locking mechanisms) can be found in the prior art of door locks; for example, U.S. Pat. No. 4,899,562 (with locking dead bolt) and U.S. Pat. No. 5,775,142 (with locking door handle) both use a solenoid to maintain a door locking mechanism in a locked or unlocked state. In such prior art of electronic door locks, the solenoid contains a spring to maintain the door locking mechanism in the locked state and is electrically powered to maintain the door locking mechanism in an unlocked state. The electrical power is typically from batteries needing short-term (≤2 yrs.) replacement to maintain the electronic door lock in operation readiness. Thus, a need has arisen for an electronic door lock that does not require batteries or the replacement of longer-term (>2 yrs.) rechargeable batteries that have gone bad.

Further there is an increasing need to place electronic door locks under home or building power management systems, which are increasingly converting to green energy, as solar power, to reduce the carbon foot-print of the home or building. Green energy mechanisms typically have low power inputs that either have to be stored over time before power conversion can be made or the green energy systems have to be large, both can be complex. Thus, a need has arisen for an electronic door locking system to be powered and controlled by a power versatile circuit to reduce the complexity of the green energy system used by home or building's power management system.

In each of these cases, power to the electronic door lock system would need to be provided across the frame to the door. Using an electrical wire can over time prove cumbersome as well as dangerous. Thus, a need has risen for an electronic door lock system to be powered through wireless means.

### SUMMARY OF THE INVENTION

In accordance with the present invention, an electronic door locking system is provided that: is not powered by standard batteries as it is wirelessly powered from an external source.

Such is accomplished through the use of a wireless charging station between the door and the door frame that can charge reusable batteries or capacitors to power the electronic door lock system. Wireless charging stations are well known in the art, for example: U.S. Pat. No. 8,760,113.

Further in accordance with the present invention, a second wirelessly powered embodiment of the electronic door locking system is provided that: is energy efficient for substantially reducing the continuous power draw on a home or building's power management system when used as the external power source, and is power versatile to allow green energy applications (such as solar power) to be the external power source.

Such is accomplished through the use of a Dual Position Latching Solenoid (DPLS) that is pulsed activated, a Bi-Stable Permanent Magnet Activation System (BSPMAS) that is power versatile. A DPLS is a permanent magnet solenoid with two magnetic latching positions. Several versions of a DPLS can be produced all having similarity to U.S. Pat. No. 3,022,450. The differences generally being the design of the moveable magnetic latching portion in the DPLS. The preferred DPLS in the present invention has a magnetic housing containing a permanent magnet and one or more control coils placed about a moveable central core that is free to move between the ends of the housing. The one or more control coils can be composed of multiple coils to reduce the input voltage and make it more usable with the BSPMAS in the present invention, as is discussed in U.S. Pat. No. 9,343,216. Such design has an outward appearance much like the solenoids used in prior art electronic door locks and similar electronic locking mechanisms. Whereas, ease in replacement can be accomplished.

The permanent magnet's placement is at the center of the DPLS with the one or more control coils place adjacent to the permanent magnet. In the DPLS of the present invention, the magnetic flux from the permanent magnet is in a bi-stable state through the moveable central core and either end of the magnetic housing. By switching a pulse of current in one of two directions through the one or more of the control coils, more magnetic flux can be diverted in one direction through the moveable central core than the other, to either increase or decrease the magnetic force toward one end of the magnetic housing; causing the moveable central core to move in the direction of the higher magnetic force. Reversing the current then causes the moveable central core to move in the opposite direction. The permanent magnet in the DPLS then allows for holding the moveable central core against the magnetic housing in either of the two directions under no power verse the continuous power application done in prior art solenoids. Whereby replacing the solenoid in prior art electronic door locks with the DPLS, an electronic door lock can be produced for maintaining a door lock mechanism in an unlocked or locked state under no power.

To allow the DPLS to be power versatile, so that it can be wirelessly powered, requires that the current through the control coil(s) be pulsed activated to cause the movement of the moveable central core to occur over a short time duration. This can be accomplished using a capacitively pulsed power system, such that the time the that the majority of the current is applied to the control coil(s) in the DPLS is mostly controlled by the stored energy in a capacitor, where shorting of the pulse time duration can be further controlled with a control circuit. One such mean specially design for the DPLS is the bi-stable permanent magnet actuator system (BSPMAS) of U.S. Pat. No. 9,343,216, which includes a power source, voltage conditioner, an energy storage capacitor, and a control circuit that controls electronic switches to activates the current to the DPLS in alternating directions.

It is noted that the control circuit for the BSPMAS would be a modification to the electronics in prior art electronic door locks, which can be wirelessly controlled; designed to connect to various wireless means, as smart-phones or wireless networks. Bluetooth devices or RF control devices.

It has been demonstrated for DPLSs—with more magnetic force than needed by the standard solenoids used in prior art electronic door lock systems—that the voltage conditioner in the BSPMAS can be a DC-DC boost powered from a 5V-USB or 5V directly from a computer. Whereby, the BSPMAS in the present invention can be easily powered using prior art wireless charging station technology across the gap between the door and frame. The wireless charging station would then provide the energy to charge a battery or capacitor to power the BSPMAS to control the DPLS in the present invention and placing the door lock mechanism in a locked or unlock state.

### BRIEF DESCRIPTION OF THE DRAWINGS

In the following, the invention is described in more detail by reference to the enclosed drawings, where

FIG. 1 shows a typical block diagram of an electronic door lock system in prior art;

FIG. 2 shows an illustration of the electronic door lock system from U.S. Pat. No. 4,899,562 for comparison with the block diagrams in FIGS. 1, 4, 7, and 8. FIG. 2A shows an external view of the electronic door lock system mounted in a door. FIG. 2B shows a cross section of the electronic door lock system mounted in a door;

FIG. 3 shows an illustration of a typical solenoid with spring to represent the solenoid in FIG. 2. FIG. 3A shows the moveable magnetic core of the solenoid pushed to the left end of the magnetic housing by the spring, when current is not applied to the coil. FIG. 3B shows the moveable magnetic core of the solenoid magnetically latched to the right end of the magnetic housing, when current is applied to the coil.

FIG. 4 shows the block diagram of FIG. 1 modified with wireless power and energy storage device;

FIG. 5 shows an illustration of one wireless charger station that can be used in the present invention across the door/frame gap to provide wireless power to an electronic door lock;

FIG. 6 shows the block diagram of FIG. 5 modified with wireless receiver and transmitter modules;

FIG. 7 shows the block diagram of FIG. 4 modified with a DPLS and BSPMAS;

FIG. 8 shows the block diagram of FIG. 7 modified with a wireless module;

FIG. 9 shows an illustration of one embodiment of a DPLS. FIG. 9A shows the moveable magnetic core of the DPLS magnetically latched to the left end of the magnetic housing. FIG. 9B shows the moveable magnetic core of the DPLS magnetically latched to the right end of the magnetic housing.

FIG. 10 shows an illustration of the BSPMAS from U.S. Pat. No. 9,343,216 modified for operation of the DPLS of FIG. 9 in an electronic door lock system.

### DETAILED DESCRIPTION

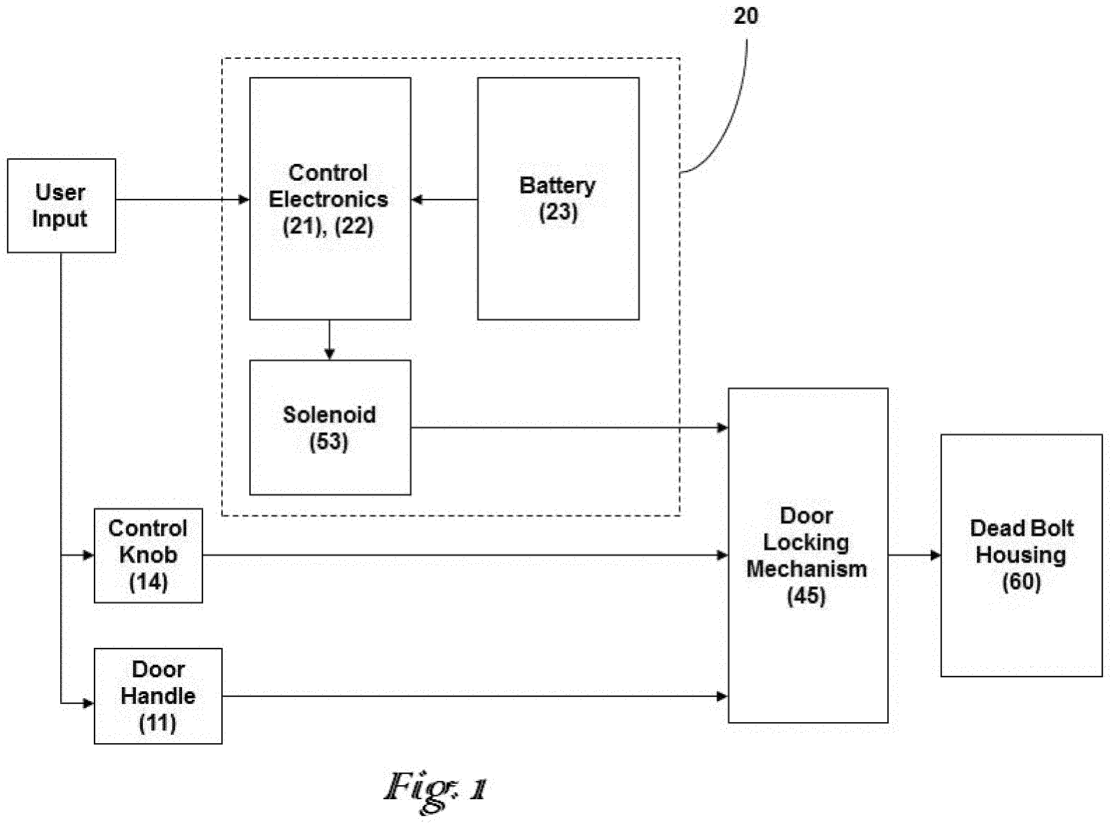

Referring to FIGS. 1-10, which are shown to facilitate the features of the present invention.

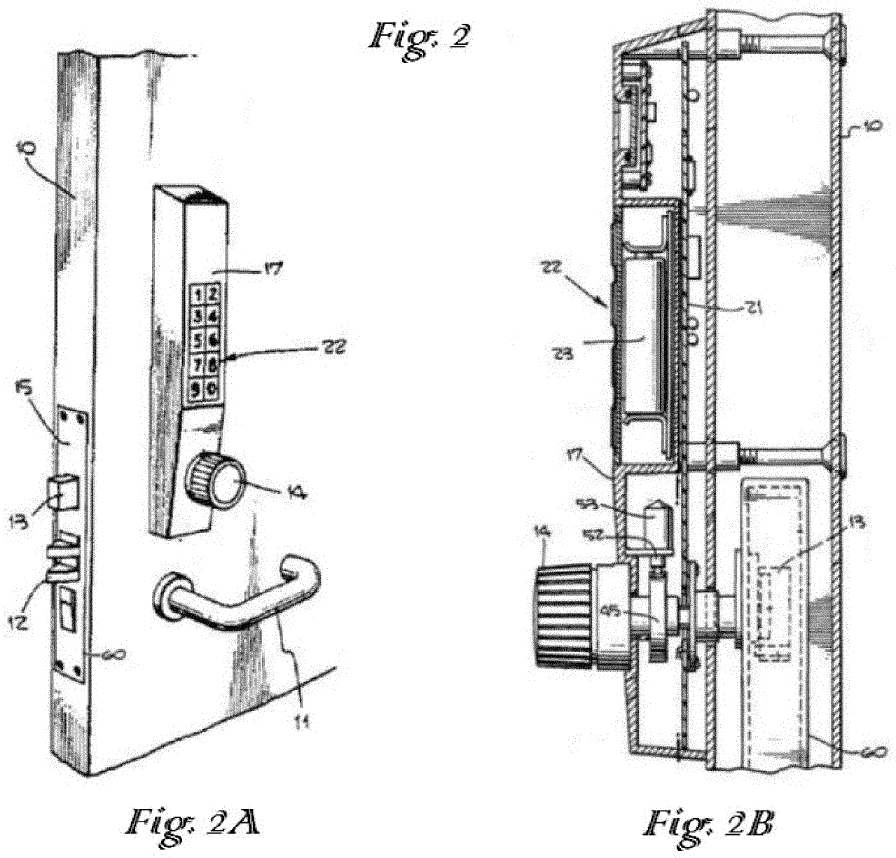

Referring to FIGS. 1-2, where FIG. 1 is a typical block diagram of an electronic door lock system in prior art and FIG. 2 is an illustration of the electronic door lock system from U.S. Pat. No. 4,899,562 to show one embodiment of an electronic door lock system containing a solenoid 53 and door locking mechanism 45 in a door 10. With reference to FIG. 1, in FIG. 2A-B, the components of the electronic door lock system comprise: an electronic door lock 20 portion in face plate 17 having control electronics comprising a printed circuit board 21 and electronic user input (key pad) 22, a battery 23, and a solenoid 53 with post 52; a door locking mechanism 45 also in face plate 17 and connected to a (user input) control knob 14; and a dead bolt housing 60 containing various mechanisms not shown and a door latch 12, dead bolt 13, and face plate 15, connected to a (user input) door handle 11.

It is understood that other solenoid 53 and door locking mechanism 45 configurations exist in the prior art without taking from the intent of the present invention. In the art of electronic door locks, the solenoid 53 is controlled by the electronic door lock 20 portion to lock or unlock the door locking mechanism 45.

It is also understood that other electronic user inputs 22 (as card readers) exist in prior art without taking from the intent of the present invention.

Further it is understood that the operation of the control electronics, and the workings of the door handle 11 and control knob 14 with the door locking mechanism 45 and with the mechanisms within the dead bolt housing 60 are well known in the art of door locks and will not be described in these specifications.

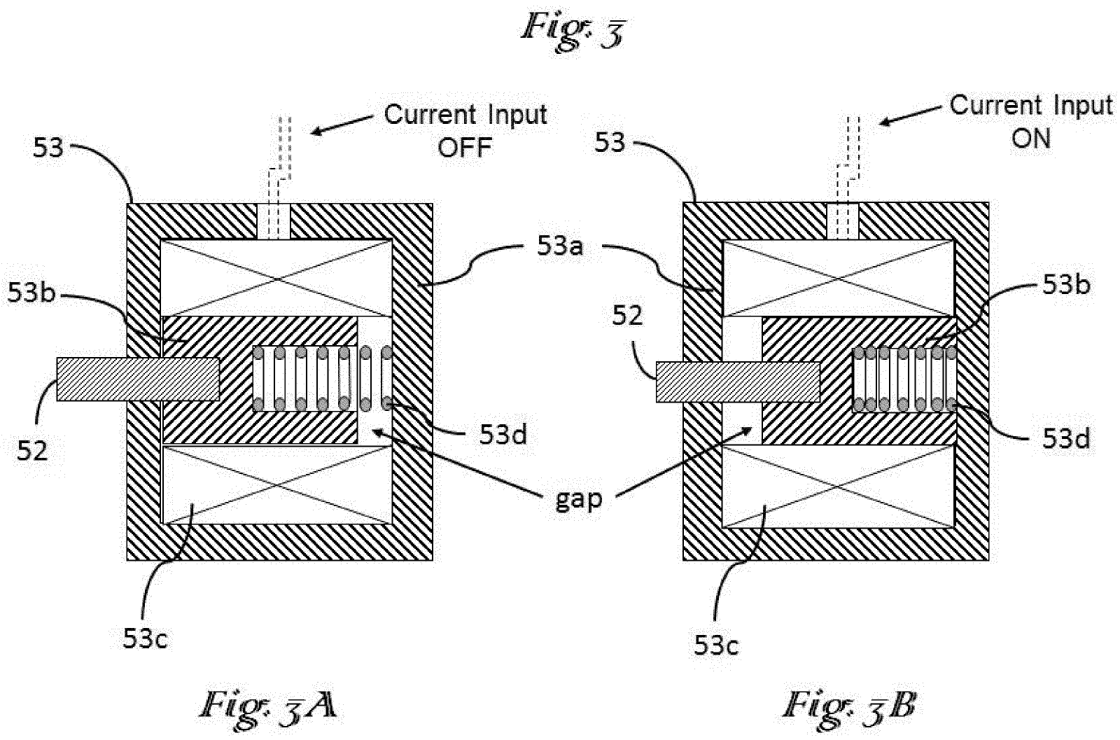

FIG. 3 is an illustration of a typical solenoid 53 for use in the present invention, where in FIG. 3A the moveable magnetic core 53b with attached post 52 is pushed to the left end of the magnetic housing 53a by a spring 53d, when the current input to the coil 53c is off, and where in FIG. 3B the moveable magnetic core 53b with attached post 52 is magnetically latched to the right end of the magnetic housing 53a, when the current input to the coil 53c is on.

It is understood that in FIG. 3 the “gap” provides the movement distance of the moveable magnetic core 53b and should be matched to the expected movement distance of the post 52 in FIG. 2.

As shown in FIG. 3, provision for the “Pulsed Current Input” to the control coils are provided in a central top location. It is understood that other provisions for the power lines in different locations can be done without taken from the intent of the present invention.

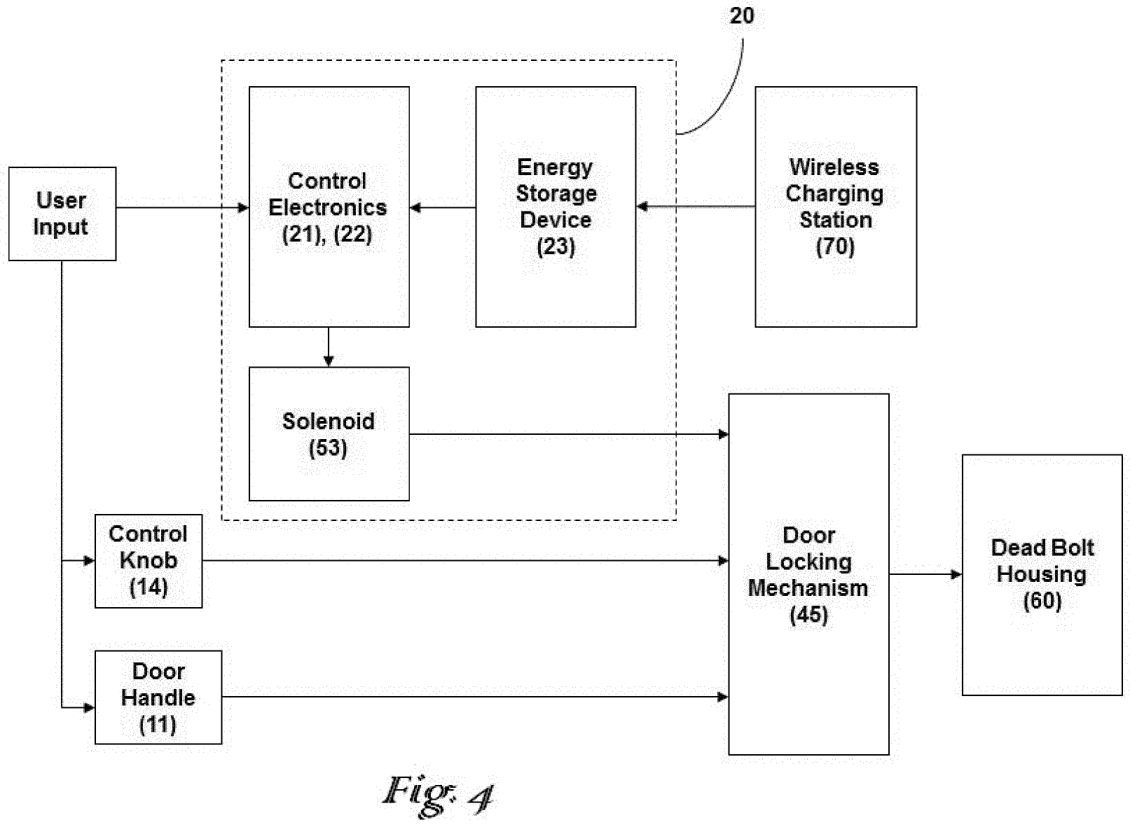

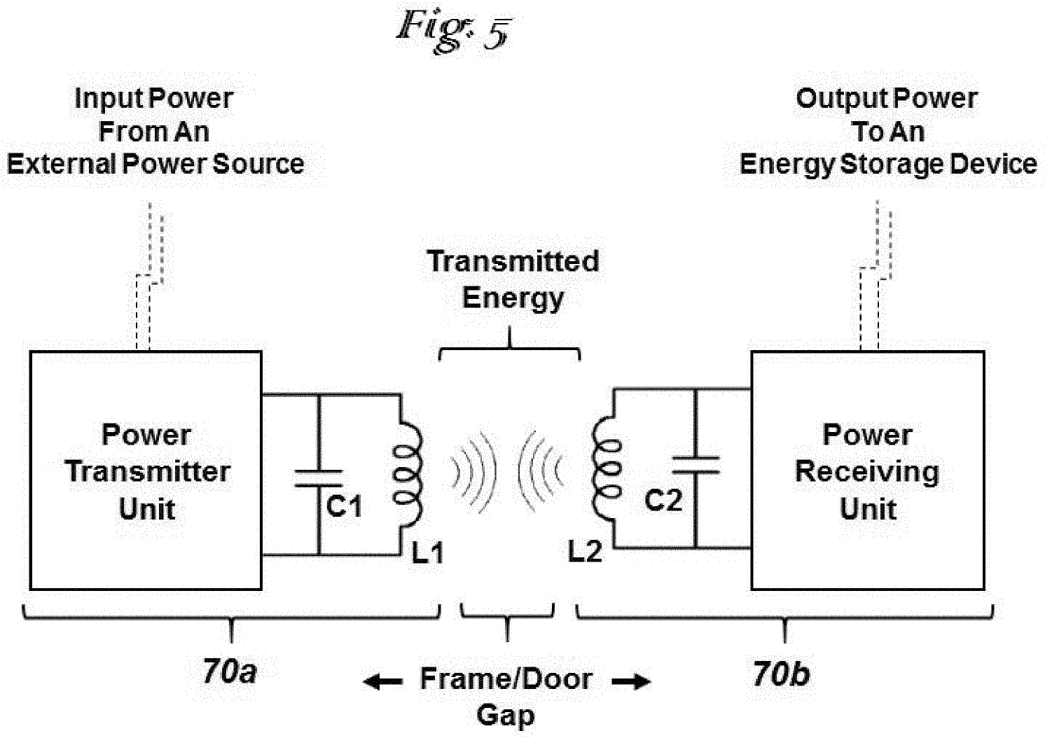

FIG. 4 is the block diagram of the electronic door lock system of FIG. 1, modified with the wireless charging station 70 (discussed further in FIG. 5) and an energy storage device 23. The energy storage device 23 replaces the battery 23 in FIG. 1, but can be rechargeable batteries or capacitors.

It is understood that capacitors, especially supercapacitors, will be better suited for the present invention as batteries may need periodic changing.

It is understood that the operation of the electronic door lock system of FIG. 4 is much the same as in prior art and will not be described in these specifications.

FIG. 5 illustrates one wireless charging station 70, known in the art of wireless power charging, that can be used in the present invention to wirelessly charge batteries or capacitors for operation of the present invention. The wireless charging station 70 shown is an inductive charger (also known as wireless charging or cordless charging) as is known in the art of wireless power charging. The wireless charging station 70 is composed of a transmitter 70a and receiver 70b, which uses an electromagnetic field to transmit energy between the transmitter 70a and receiver 70b through electromagnetic induction. Whereby, with the transmitter 70a on the door frame and the receiver 70b, respectfully adjacent, on the door, they form a wireless charging station 70, when the door is closed.

In FIG. 5, the transmitter 70a attains “Input Power” from an “External Power Source.” The power goes to a “Power Transmitter Unit” coupled to a capacitor C1 and an inductor L1, which “Transmits Energy” outward from the inductor L. In FIG. 5, the receiver 70b has a “Power Receiving Unit” coupled to a capacitor C2 and an inductor L2 that receives the “Transmitted Energy” from the inductor L1 across the “Frame/Door Gap.” The “Power Receiving Unit” conditions the attained energy to the proper voltage needed to charge the energy storage device 23 of FIG. 4.

It is understood that other wireless power systems maybe used without taken from the intent of the present invention.

It is understood that the “External Power Source” can be from the building (home, office, etc.) or facility (laboratory, factory, shop, etc.) electrical power systems, which could simply be from an electrical power outlet, where the electrical power could be from a green energy source as solar, wind, and etc.

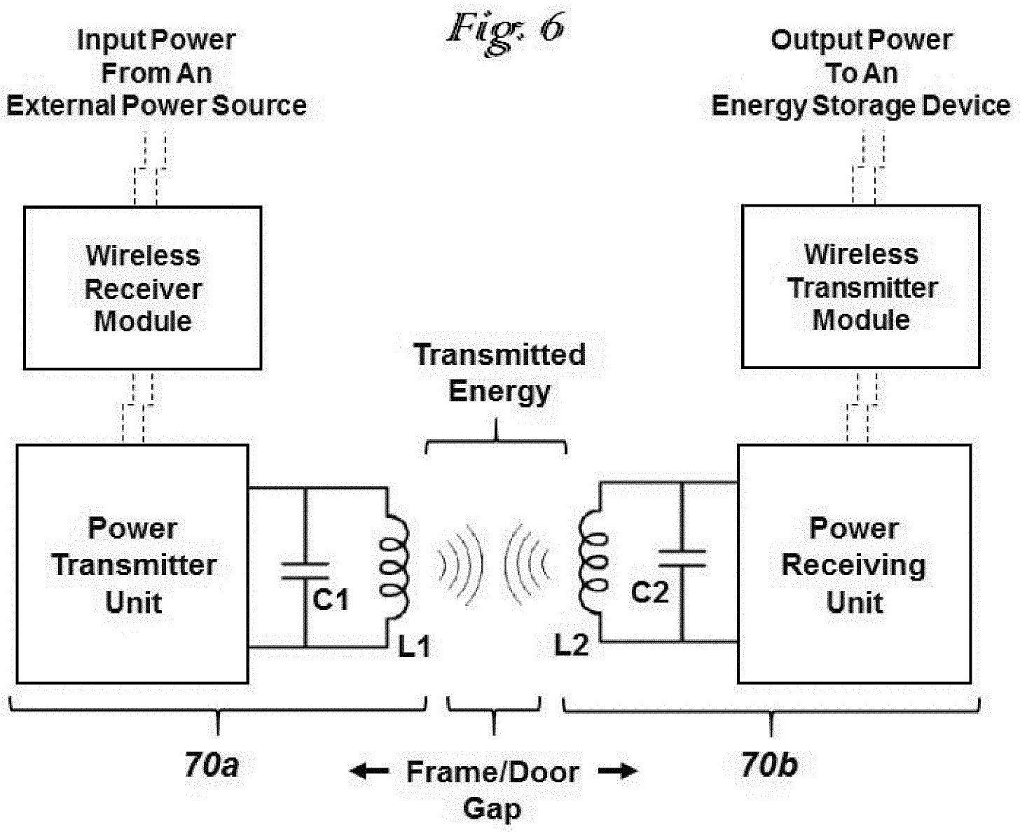

FIG. 6 is the block diagram of FIG. 5, modified with a “Wireless Transmitter Module” and “Wireless Receiver Module” to allow automatic turnoff of the “External Power Source” to the transmitter 70a when the energy storage device 23 is fully charged or automatic turn-on when the energy storage device 23 is low on power.

It is understood that a sensor for detecting the energy on the energy storage device 23 would be needed when using the wireless modules in FIG. 6.

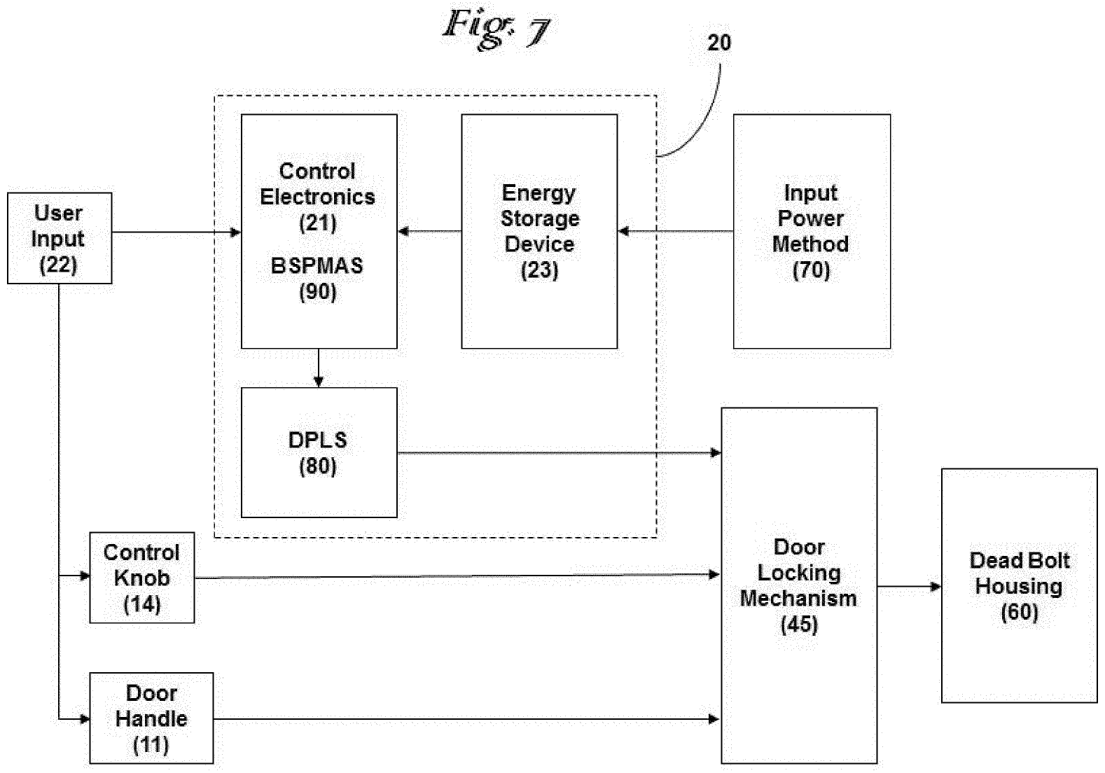

FIG. 7 is the block diagram of FIG. 4, with the solenoid 53 replaced with a Dual Position Latching Solenoid (DPLS) and with the addition of a Bi-Stable Permanent Magnet Actuation System (BSPMAS) 90 to operate the DPLS 80. The use of the DPLS 80 will inherently reduce the size of the energy storage device 23 and the amount of input power over a standard solenoid as a DPLS only requires power for a brief period during activation. That is, a DPLS 80 would not require power when the door locking mechanism 45 is in a locked or unlocked state, only during the transition of the door locking mechanism 45 from a locked or unlocked state.

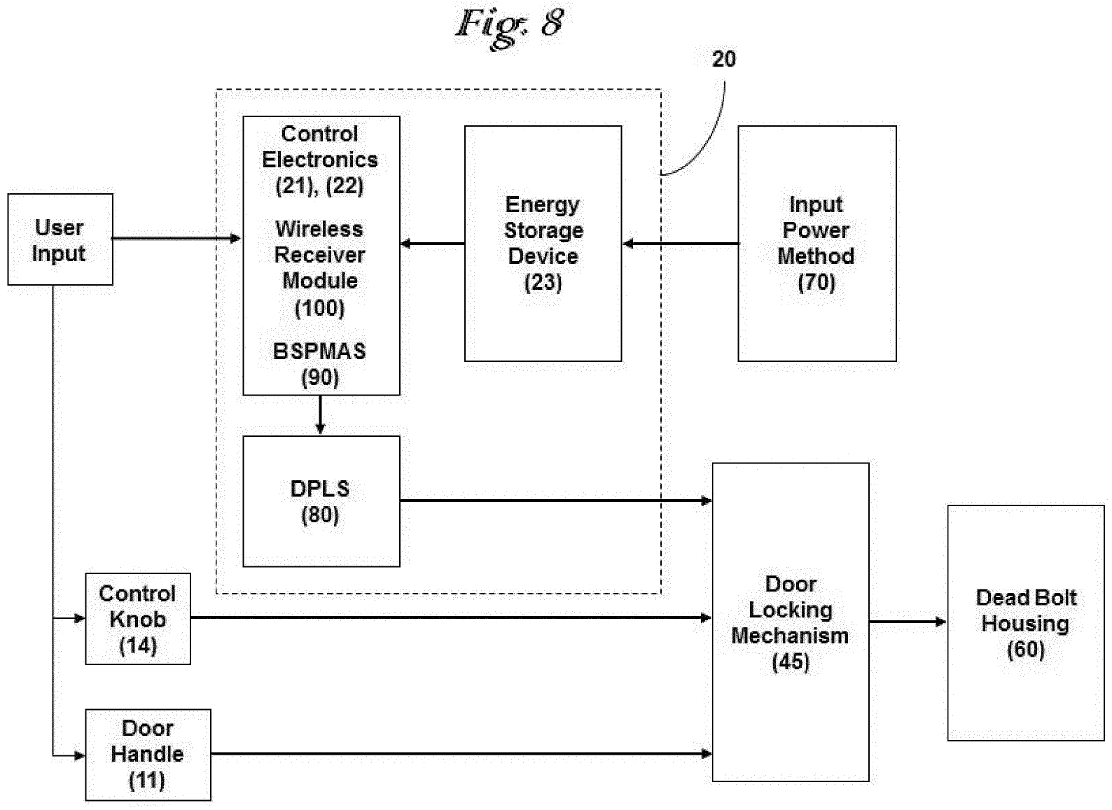

FIG. 8 is the block diagram of FIG. 7, modified with a wireless module 100, to allow remote control of the BSPMAS 90 to operate the DPLS 80 and place the door locking mechanism 45 in a locked or unlocked state.

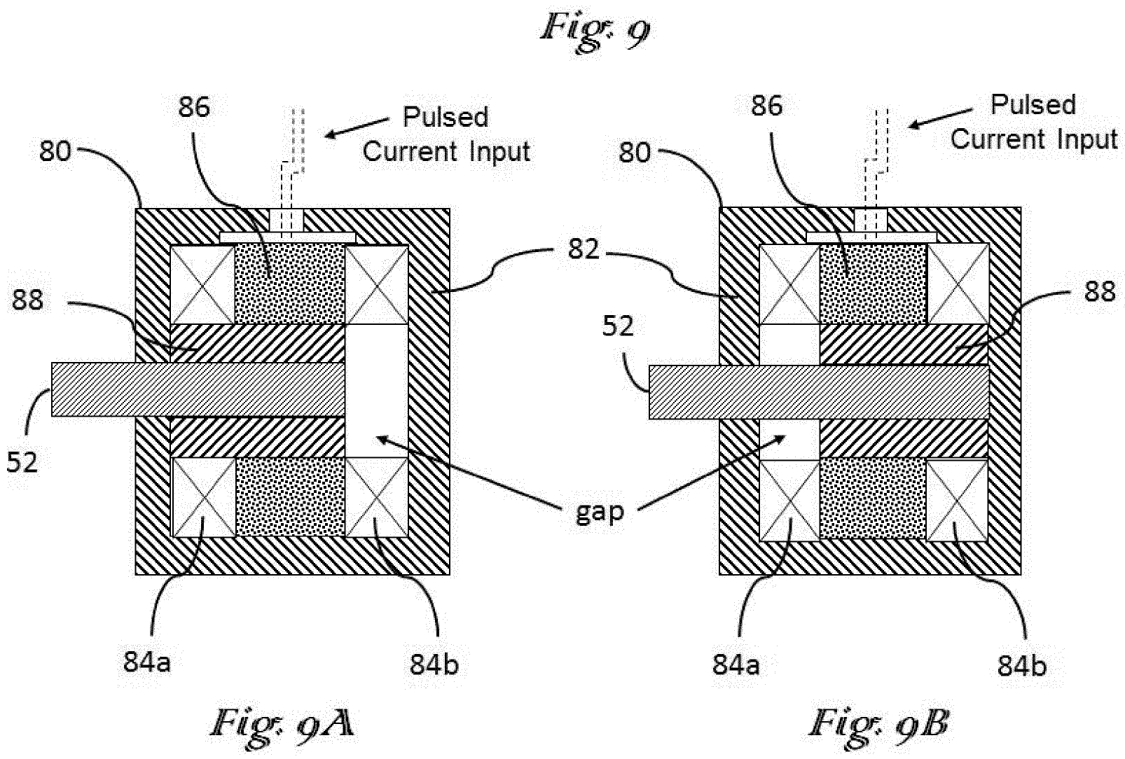

FIG. 9 is a drawing to illustrate one version of a DPLS 80 that can be used to replace the standard solenoid 53 used in electronic door lock systems, comprising a magnetic housing 82, control coils 84a and 84b, permanent magnet 86, and moveable magnetic core 88, where the post 52 of FIG. 2 is firming attached to the moveable magnetic core 88. In FIG. 9A, the moveable magnetic core 88 is magnetically latched to the left end of the magnetic housing 82, having moved the post 52 to the left as indicated by the arrow. In FIG. 9B, the moveable magnetic core 88 is magnetically latched to the right end of the magnetic housing 82, having moved the post 52 to the right as indicated by the arrow.

It is understood that in FIG. 9 the “gap” provides the movement distance of the moveable magnetic core 88 and should be matched to the expected movement distance of the post 52 in FIG. 2.

In FIG. 9, the DPLS 80 is similar to U.S. Pat. No. 3,022,450 and may have coils 84a-b composed of multiple coils for use with the BSPMAS 80 in the present invention, as is discussed in U.S. Pat. No. 9,343,216.

As shown in FIG. 9, provision for the “Pulsed Current Input” to the control coils are provided in a central top location. It is understood that other provisions for the power lines in different locations can be done without taken from the intent of the present invention.

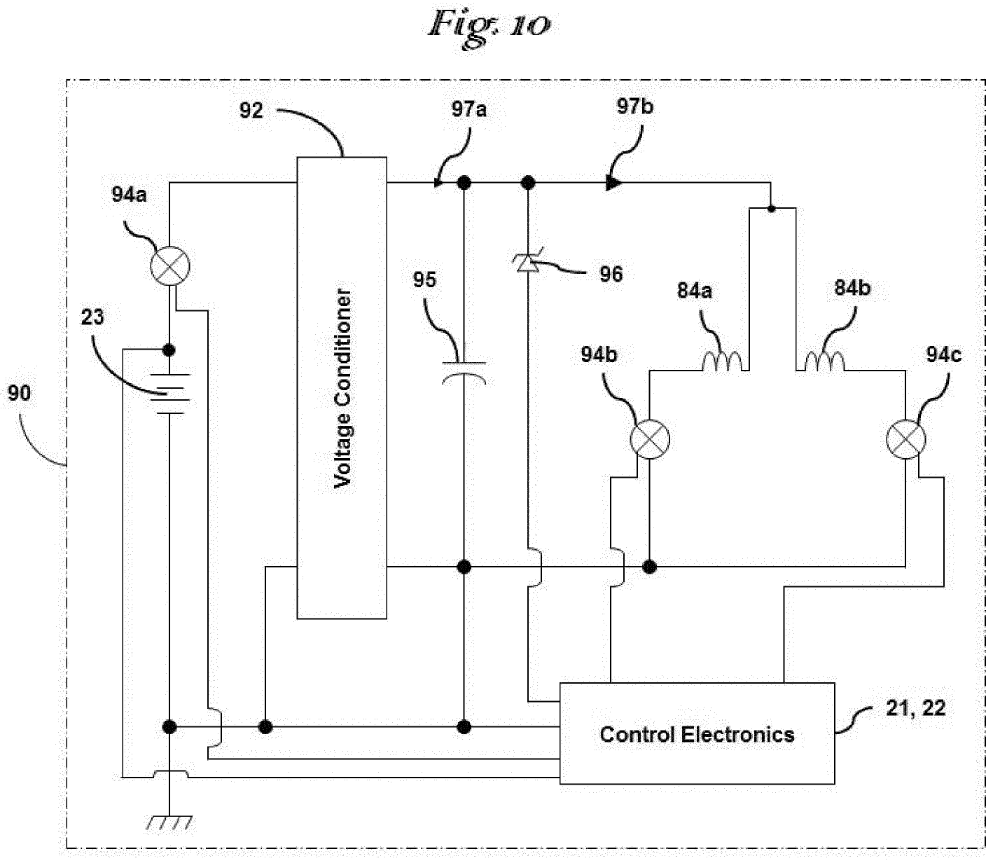

FIG. 10 illustrates a modification of FIG. 2 from the Energy Efficient Bi-Stable Permanent Magnet Actuation System (BSPMAS 90) of U.S. Pat. No. 9,343,216 for operation of the DPLS 80 in the present invention, comprising: the battery or capacitor 23 being charged by the wireless charging station 70 shown in FIG. 7; a voltage conditioner 92; electronic control 21; three switches 94a-c; a capacitor 95; and a voltage sensor 96.

It is understood that the electronic control 21 can be that currently used in the art of electronic door locks or a slight modification thereof. That is, the switches 94a-c in the BSPMAS 90 can be selected to accepted the command from the electronic control 21 that normally would operate a standard solenoid or the electronic control 21 can be modified for used with other switches selected for the BSPMAS 90.

It is also understood that a wireless module could be incorporate in the electronic door lock system to operate the BSPMAS 90 from remote devices.

Operation of the BSPMAS 90 of FIG. 10 begins by closing power source switch 94a by the electronic control 21 to allow power from the energy storage device 23 to inner the voltage conditioner 92. The voltage conditioner 92 conditions the voltage of the power source and passages a low current 97a to the storage capacitor 95 until the operation voltage of the DPLS 80 is reached. That is, the voltage on the capacitor 95 will rise with charge from the voltage conditioner 92 until the electronic control 21 senses the operation voltage through sensor %. When the electronic control 21 receives an input from user input 22, one of the switches 94b or 94c is activated to send a pulsed current 97b to one of the control coils 84a or 84b of the DPLS 80 of FIG. 9 to either lock or unlock the door locking mechanism 45.

It is understood that the switch 94a may not be needed when the BSPMAS 80 is design for very low or zero power drain between operations.

The invention claimed is:

1. A wirelessly powered, electronic door locking system having an energy storage device that does not need period changing, comprising:
a dead bolt housing, containing the mechanisms for mechanical opening and closing the door through means as a control knob or door handle;
a door locking mechanism connected to said mechanisms in said dead bolt housing, having an unlocked state to allow the opening of the door and a locked state to prevent the opening of the door;
an electronic door lock containing:
a solenoid having a moveable shaft to place said door lock mechanism in its unlocked state when a continuous current is sent to said solenoid and a spring to move said shaft to place said door lock mechanism in its locked state when a current is not being sent to said solenoid;
an energy storage device that stores the electrical energy that powers said electronic door lock and provides the continuous current to said solenoid; and
control electronics for sending the continuous current from said energy storage device to said solenoid when user input commands so;
a wireless charging station to provide the electrical power to said energy storage device, being between the door and frame when the door is closed, and powered from an external power source on the frame side of said wireless charging station; and
when said wireless charging station has charged said energy storage device, and said door lock mechanism is in the locked state, when said electronic door lock turns on a continuous current to said solenoid, to cause said moveable shaft of said solenoid to move away from said door lock mechanism; placing said door lock mechanism in the unlocked state;
when said wireless charging station has charged said energy storage device and said door lock mechanism is in the unlocked state, and when said electronic door lock stops sending the current to said solenoid, said spring in said solenoid causes said moveable shaft of said solenoid to move toward said door lock mechanism placing said door lock mechanism in the locked state;
thus to produce an electronic door locking system having an energy storage device that does not need periodic changing.

2. The electronic door locking system of claim 1, wherein said external power source is the building or facility power.

3. The electronic door locking system of claim 1, wherein said external power source is from a green energy source.

4. The electronic door locking system of claim 1, wherein said wireless charging station contains one or more wireless receiver/transmitter modules to remotely control features of the electronic door locking system.

5. An electronic door locking system that does not need a continuous current or springs to maintain a door lock mechanism in a locked or unlocked state, comprising:
a dead bolt housing, containing the mechanisms for mechanical opening and closing the door through means as a control knob or door handle;
a door locking mechanism connected to said mechanisms in said dead bolt housing, having an unlocked state to allow the opening of the door and a locked state to prevent the opening of the door;
an electronic door lock containing:
a Dual Position Latching Solenoid (DPLS) having a moveable shaft to maintain said door lock mechanism in a locked or unlocked state when a pulsed current of alternating direction is sent to said DPLS;
an energy storage device that stores the electrical energy that powers said electronic door lock and provides the pulsed current to said DPLS; and
a pulsed capacitor power and control method for sending the pulsed current of alternating direction from said energy storage device to said DPLS;
and an input power method to provide the electrical power to said energy storage device;
when said power input method is providing electrical power to said energy storage device, and said door lock mechanism is in a locked state, and when said electronic door lock tells said pulsed capacitor power and control method to send a pulsed current to said DPLS in a first alternate direction, to cause said moveable shaft of said DPLS to move away from said door lock mechanism; placing said door lock mechanism in an unlocked state;
when said power input method is providing electrical power to said energy storage device, and said door lock mechanism is in an unlocked state, and when said electronic door lock tells said pulsed capacitor power and control method to send a pulsed current to said DPLS in a second alternate direction, to cause said moveable shaft of said DPLS to move toward said door lock mechanism; placing said door lock mechanism in a locked state;
thus to produce an electronic door locking system that does not need a continuous current or springs to maintain said door lock mechanism in a locked or unlocked state.

6. The electronic door locking system of claim 5, wherein said pulsed capacitor power and control method in said electronic door lock is a modification of the BSPMAS in U.S. Pat. No. 9,343,216.

7. The electronic door locking system of claim 5, wherein said input power method contains the building or facility electrical power source.

8. The electronic door locking system of claim 5, wherein said input power method contains a green energy electrical power source.

9. The electronic door locking system of claim 5, wherein said input power method contains batteries.

10. The electronic door locking system of claim 5, wherein said input power method and said energy storage device are capacitors, charged from an electrical power source across the door and frame.

11. The electronic door locking system of claim 5, wherein said input power method contains a wireless charging station, between the door and frame when the door is closed and powered from an electrical power source on the frame side of said wireless charging station.

12. The electronic door locking system of claim 5, wherein said energy storage device is one or more rechargeable batteries.

13. The electronic door locking system of claim 5, wherein said energy storage device is one or more capacitors.

14. The electronic door locking system of claim 5, wherein said electronic door lock contains one or more wireless receiver/transmitter modules to remotely control various features of the electronic door locking system.
